(19) United States
(12) Patent Application Publication
(10) Pub. No.: US 2015/0058203 A1
(43) Pub. Date: Feb. 26, 2015

(54) SYSTEMS AND METHODS FOR PAYMENT AUTHORIZATION USING FULL-DUPLEX COMMUNICATION FROM BROWSER

(71) Applicant: EBAY INC, SAN JOSE, CA (US)

(72) Inventor: Kyryl Morozov, San Jose, CA (US)

(21) Appl. No.: 14/466,020

(22) Filed: Aug. 22, 2014

Related U.S. Application Data
(60) Provisional application No. 61/868,817, filed on Aug. 22, 2013.

(51) Int. Cl. G06Q 20/12; H04L 29/06; H04L 5/14; G06Q 20/34; G06Q 20/32

(52) U.S. Cl. CPC G06Q 20/12; G06Q 20/341; G06Q 20/3223; H04L 5/14; H04L 63/0428
USPC 705/39

(57) ABSTRACT

Systems and methods are disclosed for the use of a browser with full-duplex communication capability to securely connect the browser with a payment processing gateway for a buyer to authorize payment processing for purchases made on a webpage of a merchant. The browser may implement the full-duplex communication channels using the WebSocket Protocol to establish a secure cross-domain connection between the browser and the payment processing gateway. A buyer may place an order and enter payment information on the webpage. The browser may transmit the payment information to the payment processing gateway for payment processing. The full-duplex connection allows the payment processing gateway to return transaction data to the browser for display on the same webpage after the payment is authorized. Buyer experience is improved, the checkout flow is streamlined, and integration of the payment authorization process into the checkout flow of the merchant is simplified.

### CROSS REFERENCE TO RELATED APPLICATION

The present application claims priority to U.S. Provisional Patent Application Ser. No. 61/868,817, filed Aug. 22, 2013, which is incorporated by reference in its entirety.

### TECHNICAL FIELD

The present disclosure relates generally to electronic commerce. In particular, the present disclosure relates to methods and systems for facilitating the integration of payment authorization into the checkout flow of on-line transactions processed by merchants.

### BACKGROUND

Consumers are increasingly purchasing items and services over electronic networks, such as the Internet. Consumers routinely search for and purchase products and services from merchants and individuals alike. The transactions can take place directly between an on-line merchant or retailer and the consumer, where payment is typically made by entering credit card or other financial information. Purchasing through the Internet from the convenience of a consumer's home, office, or virtually anywhere (with mobile devices) is one main reason for the popularity of on-line purchases.

In on-line purchases, consumers may access webpages operated by merchants to place orders and complete checkout of purchases. Merchants may engage with payment service providers, like PayPal, Inc. of San Jose, Calif. to process payments for the on-line transactions. To complete the purchase, consumers may enter payment information such as credit card information or an account number with a payment service provider into a checkout page hosted on a merchant server. The merchant server may transmit the payment information to the payment service provider for payment authorization. For merchants, one disadvantage of accepting payment information through their servers is that the merchants need to be compliant with security standard of the payment card industry (PCI). PCI standard is a set of requirements designed to ensure that any companies that process, store, or transmit credit card information maintain a secure environment. To ease the PCI compliance burden, some merchants require consumers to enter payment information into a payment page hosted by the payment service provider so that the payment information does not go through the merchant server. Other merchants allow consumers to enter payment information into a checkout page of the merchants displayed on a browser. However, the browser transmits the payment information directly to the payment service provider for payment processing so as to avoid the payment information going through the merchant server. While these mechanisms ease PCI compliance burden on the merchants, they suffer from several disadvantages. For example, after authorizing the payments, the payment service provider may redirect the consumers to a separate webpage on the merchant server to display a confirmation of the transactions. This may detract from the user experience as consumers are required to interact with merchants on multiple webpages, making the checkout process more cumbersome. Furthermore, connections between the merchant server and the payment service provider and between the web browser and the payment service provider have to be opened and closed to exchange transaction information, slowing down the checkout process. The overhead of interfacing with the payment service provider also makes it more difficult for merchants to integrate the payment authorization process into the checkout flow. As such, it is desirable to have a mechanism that allows merchants to more effectively and efficiently integrate the payment authorization process into their checkout flow while reducing PCI compliance burden and simplifying the interaction between the consumers, the merchants, and the payment service providers.

### BRIEF DESCRIPTION OF THE DRAWINGS

FIG. 1 shows a buyer using a full-duplex connection between a browser on a buyer device and a payment processing gateway server to authorize payment processing for on-line purchase transactions conducted between the buyer and a merchant server according to one or more embodiments of the present disclosure;

FIG. 2 shows a flow chart of the process for the buyer to use the browser with the full-duplex connection to the payment processing gateway to authorize payment processing for purchases made from the merchant server of FIG. 1 according to one or more embodiments of the present disclosure;

FIG. 3 shows a flow chart of the process for the buyer to use the browser with the full-duplex connection to the payment processing gateway to authorize payment processing for purchases made from the merchant server of FIG. 1 where the merchant server and the payment processing gateway exchange information according to one or more embodiments of the present disclosure;

FIG. 4 shows a flow chart of the process for the merchant server to interact with the buyer on a single webpage for purchase transactions and to optionally exchange information with the payment processing gateway of FIG. 1 according to one or more embodiments of the present disclosure;

FIG. 5 shows a flow chart of the process for the payment processing gateway to use the full-duplex connection to interact with the browser on the buyer device to process payment for purchases made from the merchant server of FIG. 1 and for the payment process gateway to exchange information with the merchant server to facilitate the establishment of the full-duplex connection according to one or more embodiments of the present disclosure; and

FIG. 6 is a block diagram of a computer system suitable for implementing one or more components discussed herein according to one embodiment of the present disclosure.

Embodiments of the present disclosure and their advantages are best understood by referring to the detailed description that follows. It should be appreciated that like reference numerals are used to identify like elements illustrated in one or more of the figures.

### DETAILED DESCRIPTION

Systems and methods are disclosed herein for the use of a browser with full-duplex communication capability to securely connect the browser with a payment processing gateway for a buyer to authorize payment processing for on-line purchases made on a webpage of a merchant. The browser may implement the full-duplex communication channels using the WebSocket Protocol to establish a secure cross-domain connection between the browser and the payment processing gateway. A buyer may place an order and enter payment information on a webpage of the merchant hosted on a merchant server. The webpage may be written in HyperText Markup Language 5 (HTML5) to support the WebSocket Protocol. The browser may transmit the payment information from the buyer device to the payment processing gateway. The payment processing gateway may process the payment information through a payment processing network. The full-duplex connection allows the payment processing gateway to return transaction data after the payment is authorized to the browser so that the buyer is not redirected to a different webpage. The browser may display a confirmation of the payment authorization on the same merchant webpage into which the payment information was entered. The browser may transmit the transaction data received from the payment processing gateway to the merchant server for the merchant server to complete the purchase transaction. Optionally, the merchant server and the payment processing gateway may exchange information to facilitate the establishment of the full-duplex connection between the browser and the payment processing gateway. For example, merchant server may request and receive from the payment processing gateway tokens that may be returned to the browser for the browser to connect to the payment processing gateway.

The secure, open full-duplex communication channel between the browser and the payment processing gateway requires less overhead for bi-directional communication compared to conventional channels that require the browser to solicit data from the payment processing gateway. Advantageously, the buyer experience is improved because the buyer may authorize and confirm payment transactions from a single checkout webpage. Integration of the payment authorization process into the checkout flow of the merchant is also simplified when payment authorization uses a WebSocket-supported browser to connect a checkout webpage with a payment processing gateway. Furthermore, no payment information is passed through the merchant server, reducing the PCI compliance burden on the merchant.

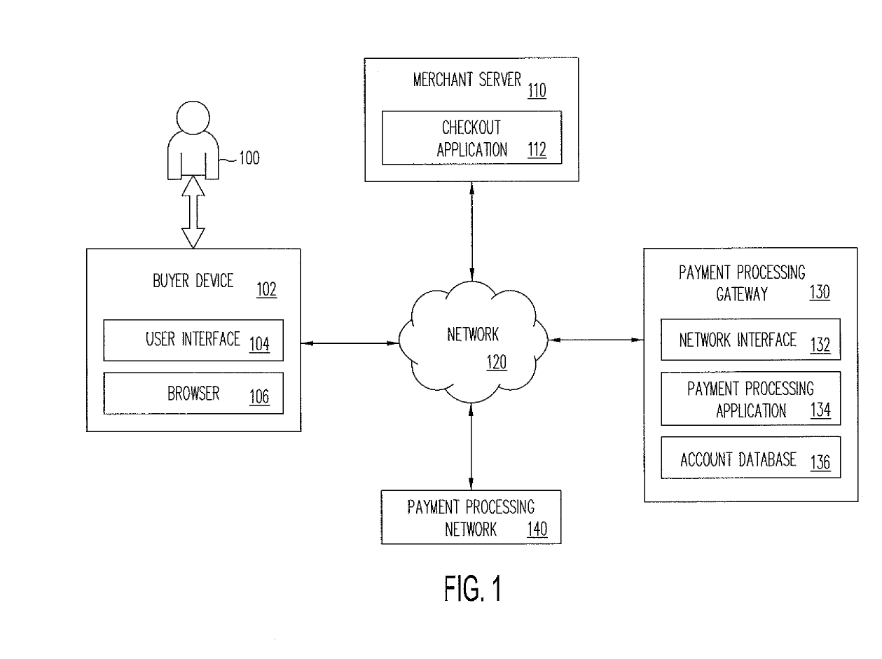

Refer now to the figures wherein the drawings are for purposes of illustrating embodiments of the present disclosure only, and not for purposes of limiting the same. FIG. 1 shows a buyer using a full-duplex connection between a browser on a buyer device and a payment processing gateway server to authorize payment processing for on-line purchase transactions conducted between the buyer and a merchant server according to one or more embodiments of the present disclosure. FIG. 1 is discussed in the context of a product purchase from a merchant. However, the systems and methods discussed in FIG. 1 may be generalized to include the purchase of services from a service vendor. The systems and methods may also include the purchase of goods or services from electronic marketplaces that include a conglomeration of various merchants, service vendors, and e-commerce sites.

A buyer 100 uses a buyer device 102 to make an online purchase. Buyer 100 may use a user interface 104 on buyer device 102 to purchase products over a network 120. For example, buyer 100 may open an Internet browser 106 to purchase products from various merchants and to authorize payments over the Internet. Browser 106 may support full-duplex communication channels such as the WebSocket Protocol that provides secure cross-domain connections between browser 106 and other devices. A merchant server 110 operated by a merchant may host webpages of products offered by the merchant. Buyer 100 may download webpages of products for viewing on browser 106. Information on a webpage may include the name of the merchant, the description of the products, and their selling price. Buyer 100 may place an order on the webpage to purchase a product. Merchant server 110 may invoke a checkout application 112 to process purchase transactions from buyer device 102. Checkout application 112 may display a checkout page that allows buyer 100 to specify the payment option for the purchase. Payment is processed by a payment processing gateway 130 and a payment processing network 140. Browser 106 may establish a full-duplex connection with payment processing gateway 130 to authorize payment processing for the purchase.

In one or more embodiments, merchant server 110 may exchange information with payment processing gateway 130 prior to payment authorization. Merchant server 110 may use the information to facilitate the purchase transaction or to facilitate the establishment of the full-duplex connection between browser 106 and payment processing gateway 130. For example, when merchant server 110 invokes checkout application 112 to process the purchase transaction, checkout application 112 may issue a call to payment processing gateway 130 to request a security token. The request may be accompanied by information about the purchase transaction. Payment processing gateway 130 may transmit an application programming interface (API) response containing the requested security token back to checkout application 112. The API response may also contain information on the different payment options that are accepted by payment processing gateway 130 for the purchase transaction. Checkout application 112 may return the security token and/or the information on the payment options to browser 106. Browser 106 may display the different payment options on the checkout page. For example, the payment options may include paying by credit cards or accounts with a payment service provider that operates payment processing gateway 130. In one or more embodiments, merchant server 110 may not exchange information with payment processing gateway 130 prior to payment authorization. In this case, browser 106 may display the checkout page showing a default set of payment options.

Buyer device 102 that runs browser 106 may be a smart phone (e.g., iPhone, Google phone, or other phones running Android, Window Mobile, or other operating systems), a tablet computer (e.g., iPad, Galaxy), personal digital assistant (PDA), a notebook computer, or various other types of wireless or wired computing devices. It should be appreciated that buyer device 102 may be referred to as a client device or a customer device without departing from the scope of the present disclosure. Buyer device 102 may communicate over a network 120 with merchant server 110 and with payment processing gateway 130.

Network 120 may be implemented as a single network or a combination of multiple networks. For example, in various embodiments, network 120 may include the Internet and/or one or more intranets, wireless networks (e.g., cellular, wide area network (WAN), WiFi hot spot, WiMax, personal area network (PAN), Bluetooth, etc.), landline networks and/or other appropriate types of communication networks. As such, in various embodiments, user device 102 may be associated with a particular link (e.g., a link, such as a URL (Uniform Resource Locator) to an IP (Internet Protocol) address).

Browser 106 may request a secure full-duplex communication channel with payment processing gateway 130 to be used for payment authorization. In one or more embodiments, browser 106 may make the request without a security token. In other embodiments, browser 106 may make the request accompanied by a security token that is received by checkout application 112 after the exchange of information between checkout application 112 and payment processing gateway 130 prior to payment authorization. Payment processing gateway 130 may accept the request by transmitting an acknowledgement. The secure full-duplex communication channel may be implemented using WebSocket Protocol that allows payment processing gateway 130 to transmit payment transaction data to browser 106 when data becomes available without being solicited by browser 106. The secure full-duplex communication may also enable cross-domain requests when the checkout page and payment processing gateway 130 are on different domains.

Buyer 100 may enter the payment information on the checkout page. For example, buyer 100 may fill out the credit card fields on the checkout page to authorize a payment using a credit card. In one or more embodiments, buyer 100 may enter bank account information to request an automatic clearing house (ACH) withdrawal from a checking account. In one or more embodiments, buyer 100 may enter an account number of an account with the payment service provider when paying with the account which may have a linked funding source. Browser 106 may transmit the payment information to payment processing gateway 130 through the secure full-duplex communication channel over network 120. Because the payment information does not pass through merchant server 110, the burden on the merchant to be PCI compliant is reduced. Browser 106 may also transmit account information of the merchant to payment processing gateway 130 for payment to be credited to the merchant's account.

Payment processing gateway 130 may include a network interface 132, a payment processing application 134, and an account database 136. Network interface 132 interfaces with network 120 to exchange information with browser 106 over the secure full-duplex communication channel. For example, network interface 132 may receive the payment information and account information of the merchant from browser 106. Network interface 132 may also interface with merchant server 110 to respond to the request for security tokens and may interface with payment processing network 140 to exchange information for payment processing. Payment processing application 134 may receive the payment information and account information of the merchant from network interface 132. If the payment information indicates payment from an account with the payment service provider, payment processing application may search account database 136 to verify the account information. If buyer 100 does not have an account, buyer 100 may be asked to establish an account and to link a funding source to the account. If buyer 100 has an account, payment processing application 134 may debit the account or may debit the funding source linked to the account if the balance in the account is insufficient to cover the payment amount. If the payment information indicates payment by a credit card, an ACH withdrawal, or through the funding source linked to the account with the payment service provider, payment processing gateway 130 may transmit the payment information to payment processing network 140 for processing. Payment processing network 140 may be a network of credit card clearance houses, credit card issuing banks, financial institutions holding funding sources of buyer 100 or the merchant's account, etc. Payment processing network 140 may debit the payment from the payment source and may credit the payment to the merchant's account. When payment processing is successfully executed, payment processing network 140 may return a transaction ID to payment processing gateway 130.

Payment processing gateway 130 may transmit the transaction ID and other transaction status information to browser 106 through the secure full-duplex communication channel. Because the full-duplex channel enables payment processing gateway 130 to transmit the transaction status information back to browser 106 as soon as the information becomes available rather than waiting for browser 106 to solicit the information, the checkout flow is expedited. In addition, browser 106 may display the transaction status information on the same checkout page from which payment was authorized rather than redirecting buyer 100 to a different webpage, thus streamlining the checkout flow. Browser 106 may display on the checkout page a status message and a transaction ID confirming that the payment was successfully processed. If the payment processing fails for any reason, the checkout page may display a failure page and may direct buyer 100 to reauthorize payment using a different funding source.

Browser 102 may transmit transaction-related data to merchant server 110. The transaction-related data may contain the transaction status information and the transaction ID from payment processing gateway 130. The transaction-related data may also contain information for the merchant to fulfill the purchase transaction such as a shipping address and a selected shipping method. Checkout application 112 may process the transaction-related data to transmit a response to browser 106. The response may be a webpage confirming the successful execution of the purchase order and may contain information such as a description of the product, a purchase price, an expected shipping or receiving date, etc. Browser 106 may display the response to complete the purchase transaction.

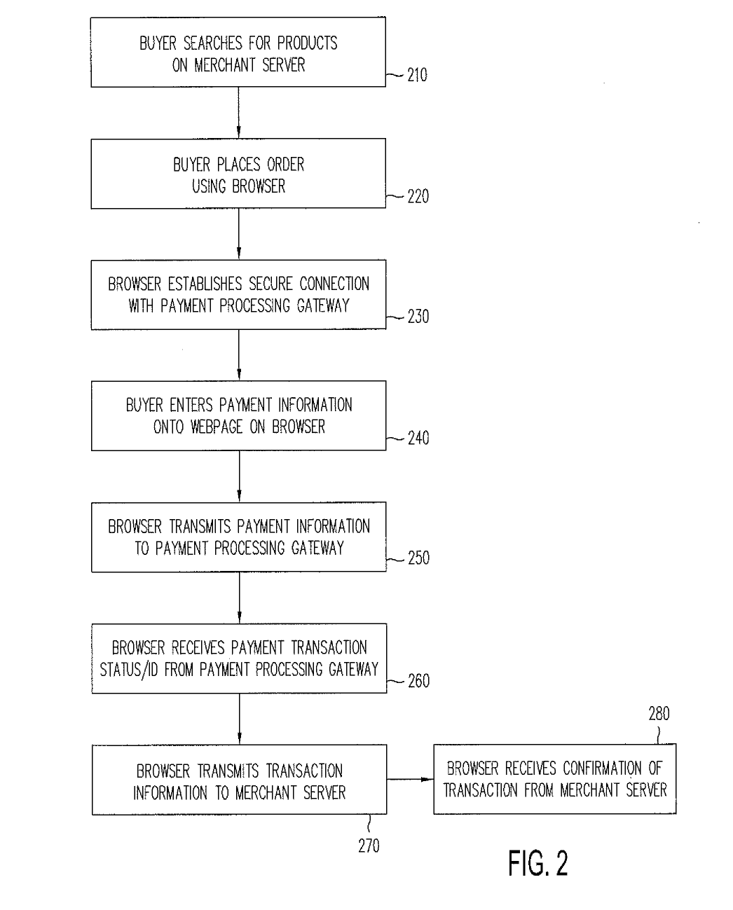

FIG. 2 shows a flow chart of the process for the buyer to use the browser with the full-duplex connection to the payment processing gateway to authorize payment processing for purchases made from the merchant server of FIG. 1 according to one or more embodiments of the present disclosure.

In 210, buyer 100 uses buyer device 102 to make an online purchase. Buyer 100 may use a browser 106 that supports WebSocket Protocol or other full-duplex communication channels between browser 106 and other devices. Buyer 100 may download webpages of products or service from merchants, vendors, electronic marketplaces, and other e-commerce sites for display on browser 106.

In 220, buyer 100 places an order on a webpage of a merchant. The webpage may transmit to merchant server 110 information on the order. Buyer 100 may be directed to a checkout page that displays information about the order, the purchase price and a choice of payment options that buyer 100 may select to authorize payment for the purchase. The choice of payment options may be a function of the purchase price.

In 230, browser 106 establishes a secure full-duplex connection with payment processing gateway 130. The secure full-duplex connection may be implemented by WebSocket Protocol that is supported by browser 106 for making cross-domain requests. Browser 106 may use the connection to transmit payment information from buyer 100 to payment processing gateway 130 to authorize payment processing for the purchase. In addition, payment processing gateway 130 may use the full-duplex connection to return status information on the payment processing to browser 106 without being solicited by browser 106. Browser 106 may issue a request to payment processing gateway 130 to open the secure full-duplex connection. In one or more embodiments, the request may be accompanied by a security token. Browser 106 may receive an acknowledgement from payment processing gateway 130 that the connection is opened when payment processing gateway 130 accepts the connection request.

In 240, buyer 100 enters payment information onto the checkout page displayed by browser 106. Buyer 100 may select a payment option for the purchase and may enter payment information for the selected payment selection. For example, buyer 100 may enter the credit card number, expiration date, name and address of the card holder, etc., if paying by credit cards. Buyer 100 may verify the payment information and may click a submit button to submit the payment information to payment processing gateway 130.

In 250, browser 106 transmits information such as the payment amount, the payment information from buyer 100, and account information of the merchant over the secure full-duplex connection to payment processing gateway 130 to authorize the payment. The account information of the merchant may be derived from the checkout page. Payment processing gateway 130 may process the payment with the aid of payment processing network 140 to debit the payment amount from the payment source and to credit the payment amount to the merchant's account. Because the payment information does not pass through the merchant, the burden on the merchant to be PCI compliant is reduced.

In 260, browser 106 receives the results of the payment processing from payment processing gateway 130 over the secure full-duplex connection. The results may include transaction status such as a confirmation that the payment processing has been successfully executed, a transaction ID, and transaction-related data to be passed to the merchant. Browser 106 may display the results of the payment processing intended for viewing by buyer 100 on the checkout page. For example, browser 106 may display a confirmation message and the transaction ID. Browser 106 may receive the results of the payment processing as soon as the results are available from payment processing gateway 130, thus expediting the checkout flow.

In 270, browser 106 transmits transaction-related data to the merchant. The transaction-related data may be generated by the checkout page and/or may be received from payment processing gateway 130. For example, the transaction-related data may include the final payment amount, non-payment information entered by buyer 100 on the checkout page such as a shipping address, a selected shipping method, etc., and the transaction status and the transaction ID received from payment processing gateway 130.

In 280, browser 106 receives a continuation response from the merchant. The confirmation response may confirm the successful execution of the order. The confirmation response may display on a confirmation webpage showing a description of the purchases, the total price charged to buyer 100 from the selected payment source, an expected shipping date, etc. The confirmation response may close the secure full-duplex connection between browser 106 and payment processing gateway 120.

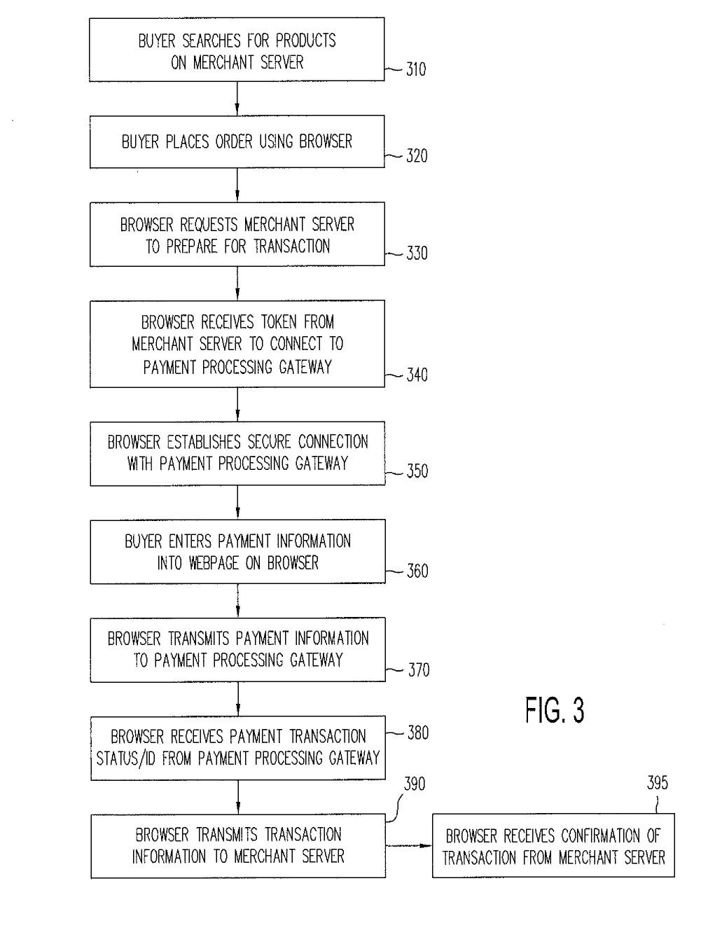

FIG. 3 shows a flow chart of the process for the buyer to use the browser with the full-duplex connection to the payment processing gateway to authorize payment processing for purchases made from the merchant server of FIG. 1 where the merchant server and the payment processing gateway exchange information according to one or more embodiments of the present disclosure. FIG. 3 differs from FIG. 2 in that merchant server 110 may receive tokens from payment processing gateway 130 to pass on to browser 106. Browser 106 may use the tokens to establish the full-duplex connection with payment processing gateway 130.

In 310, buyer 100 uses buyer device 102 to search for products on merchant server 110 and to place an order on a webpage of the merchant. The operations for 310 and 320 may be the same as those described for 210 and 220, respectively, of FIG. 2 and will not be repeated. In 330, browser 106 transmits a request for merchant server 110 to prepare for the purchase transaction. Merchant server 110 may exchange information with payment processing gateway 130 to facilitate the purchase transaction. For example, checkout application 112 of merchant server 110 may issue a call to payment processing gateway 130 to request a security token. Checkout application 112 may transmit information on the purchase transaction such as the purchase amount to payment processing gateway 130 as part of the call request. Payment processing gateway 130 may process the call request to return an API response containing a security token to checkout application 112. The API response may contain other information such as the payment options that are accepted by payment processing gateway 130. Checkout application 112 may use the information returned by payment processing gateway 130 to facilitate the purchase transaction, such as to update the payment options on the checkout page. Checkout application 112 may transmit the security token to browser 106 to aid browser 106 in establishing the secure full-duplex connection with payment processing gateway 130.

In 340, browser 106 receives the security token from checkout application 112. The security token identifies the purchase transaction for which payment processing gateway 130 will be requested to process payment. Browser 106 may transmit the security token as part of a request to payment processing gateway 130 to open the secure connection. In one or more embodiments, browser 106 may make the request without using a security token or may use other mechanisms for identifying the purchase transaction to payment processing gateway 130.

In 350, browser 106 establishes a secure full-duplex connection with payment processing gateway 130. In 360, buyer 100 enters payment information onto the checkout page displayed on browser 106. In 370, browser 106 transmits the payment information over the secure full-duplex connection to payment processing gateway 130 to authorize the payment. In 380, browser 106 receives the results of the payment processing from payment processing gateway 130 over the secure full-duplex connection. In 390, browser 106 transmits transaction-related data to merchant server 110. In 395, browser 106 receives a confirmation response from merchant server 110. The operations for 350, 360, 370, 380, 390, and 395 may be the same as those described for 230, 240, 250, 260, 270, and 280, respectively, of FIG. 2 and will not be repeated.

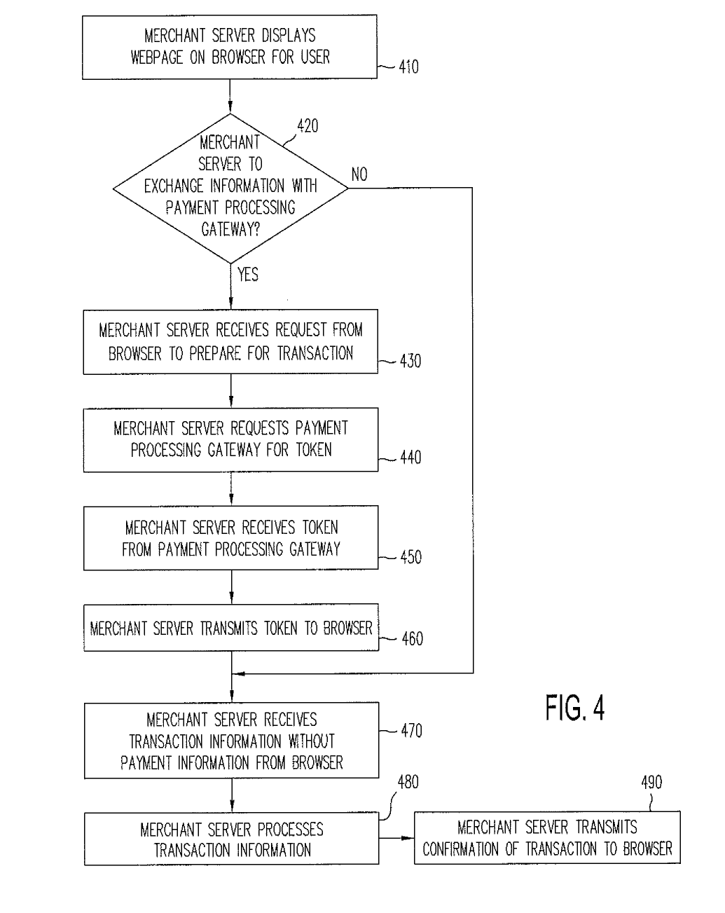

FIG. 4 shows a flow chart of the process for the merchant server to interact with the buyer on a single webpage for purchase transactions and to optionally exchange information with the payment processing gateway of FIG. 1 according to one or more embodiments of the present disclosure.

In 410, merchant server 110 operated by the merchant hosts webpages of products offered by the merchant. The webpages may contain information such as descriptions of the products, their selling price, etc. When requested by buyer 100 from buyer device 102, the merchant may download a webpage to browser 106. Buyer 100 may place an order on the webpage to purchase a product. When merchant server 110 receives the order, merchant server 110 may invoke checkout application 112 to process the purchase transaction. Checkout application 112 may download a checkout page to browser 106 for buyer 100 to enter payment information.

In 420, merchant server 110 determines if it desires to exchange information with payment processing gateway 130 to prepare for the purchase transaction. Merchant server 110 may use the info illation to facilitate the purchase transaction or to facilitate the establishment of the secure full-duplex connection between browser 106 and payment processing gateway 130. For example, merchant server 110 may use the information obtained from payment processing gateway 130 to determine the payment options offered to buyer 100. In one or more embodiments, merchant server 100 may pass security tokens received from payment processing gateway 130 to buyer device 102. Buyer device 102 may transmit the security token to payment processing gateway 130 to identify the purchase transaction when browser 106 requests payment processing gateway 130 to establish the secure full-duplex connection.

If merchant server 110 desires to exchange information with payment processing gateway 130, merchant server 110 may wait for a confirmation from browser 106 indicating that buyer 100 wishes to proceed with the purchase transaction. In 430, merchant server 110 receives a request from browser 106 to prepare for the purchase transaction. In 440, merchant server 110 issues a call to payment processing gateway 130 to request a security token. The call request may include information on the purchase transaction such as the purchase amount. Payment processing gateway 130 may process the call request to return an API response containing a security token. In 450, merchant server 110 receives the security token from payment processing gateway 130. The security token identifies the purchase transaction for which payment processing gateway 130 will be requested to process payment. In 460, merchant server 110 transmits the security token to browser 106. Browser 106 may transmit the security token as part of a request to payment processing gateway 130 to open the secure full-duplex connection.

If, in 420, merchant server 110 determines that it does not desire to exchange information with payment processing gateway 130, merchant server 110 may forgo requesting a security token from payment processing gateway 130 to pass on to browser 106. Browser 106 may thus request payment processing gateway 130 to open the secure full-duplex connection without including a security token as part of the request. Browser 106 may use other mechanisms to identify the purchase transaction to payment processing gateway 130 when requesting the secure full-duplex connection. After the secure full-duplex connection is established, buyer 100 may enter payment information on the checkout page to authorize payment processing gateway 130 to process the payment. Browser 106 may receive transaction-related data from payment processing gateway 130 when the payment processing is successfully executed. The transaction-related data may include information on the transaction status and a transaction ID.

In 470, merchant server 110 receives the transaction-related data from browser 106. The transaction-related data may include the final payment amount, the transaction status and the transaction ID received from payment processing gateway 130, and non-payment information entered by buyer 100 on the checkout page such as the shipping address, the selected shipping method, etc. The transaction-related data does not include the payment information entered by buyer 100 on the checkout page and transmitted by browser 106 to payment processing gateway 130 to authorize payment processing. Because merchant server 110 does not receive the payment information, the burden on the merchant for PCI compliance is reduced.

In 480, merchant server 110 processes the transaction related information to generate a confirmation response. The confirmation response may confirm the successful execution of the purchase order and may contain information such as a description of the product, the final purchase price, an expected shipping or receiving date of the product, etc. In 490, merchant server 110 transmits the confirmation response to browser 106 to complete the purchase transaction.

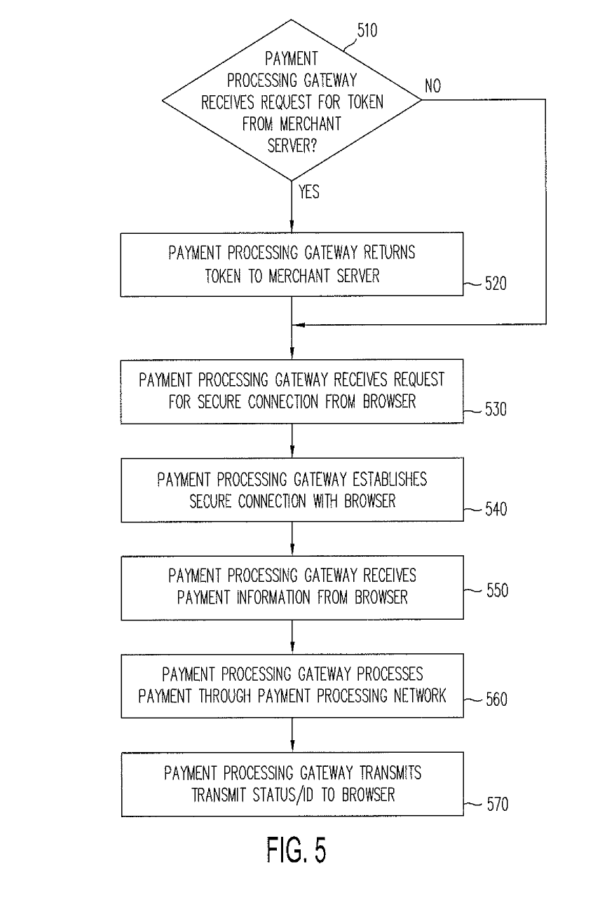

FIG. 5 shows a flow chart of the process for the payment processing gateway to use the full-duplex connection to interact with the browser on the buyer device to process payment for purchases made from the merchant server of FIG. 1 and for the payment process gateway to exchange information with the merchant server to facilitate the establishment of the full-duplex connection according to one or more embodiments of the present disclosure.

In 510, payment processing gateway 130 determines if it receives a request for a security token from merchant server 110 for a purchase transaction. Merchant server 110 may request the security token to facilitate the establishment of the secure full-duplex connection between browser 106 and payment processing gateway 130. The request may include information on the purchase transaction such as the purchase amount. In one or more embodiments, payment processing gateway 130 may receive from merchant server 110 requests for other information that may facilitate the purchase transaction. For example, payment processing gateway 130 may provide information on the payment options offered to buyer 100 for the purchase transaction.

In 520, if payment processing gateway 130 receives a request for a security token, payment processing gateway 520 processes the request to return an API response containing the security token to merchant server 110. The security token identifies the purchase transaction for which payment processing gateway 130 will be requested to process payment. Merchant server 110 may transmit the security token to browser 106. Browser 106 may transmit the security token as part of the request to payment processing gateway 130 to establish the secure full-duplex connection. If, in 510, payment processing gateway 130 does not receive the request for a security token, browser 106 may request payment processing gateway 130 to establish the secure full-duplex connection without including a security token as part of the request. In one or more embodiments, browser 106 may use other mechanisms to identify the purchase transaction to payment processing gateway 130 when requesting the secure full-duplex connection.

In 530, payment processing gateway 130 receives a request from browser 106 to establish the secure full-duplex connection. The request may or may not be accompanied by a security token as discussed. In 540, payment processing gateway 130 accepts the request. Payment processing gateway 130 may open the secure full-duplex connection and may transmit an acknowledgement to browser 106 confirming that the connection is open.

In 550, payment processing gateway receives payment information from browser 106 over the secure full-duplex connection. The payment information may include information on a payment source of buyer 100 such as information on a credit card, a bank account, an account number with the payment service provider, etc., entered by buyer 100 on a checkout page. The payment information may also include information on a receiving account of the merchant to receive the payment.

In 560, payment processing gateway 130 transmits the payment information to payment processing network 140 for processing. Payment processing network 140 may debit the payment amount from the payment source of buyer 100 and may credit the payment amount to the merchant's account. When payment processing is successfully executed, payment processing network 140 may return a transaction ID to payment processing gateway 130

In 570, payment processing gateway 130 transmits the transaction ID, a transaction status, and other transaction-related information to browser 106 over the secure full-duplex connection. The transaction status may include a confirmation that the payment processing has been successfully executed. Browser 106 may transmit the transaction information received from payment processing gateway 130 as well as non-payment information entered by buyer 100 on the checkout page to merchant server 110 to confirm to the merchant 110 that the payment has been credited to the merchant's account.

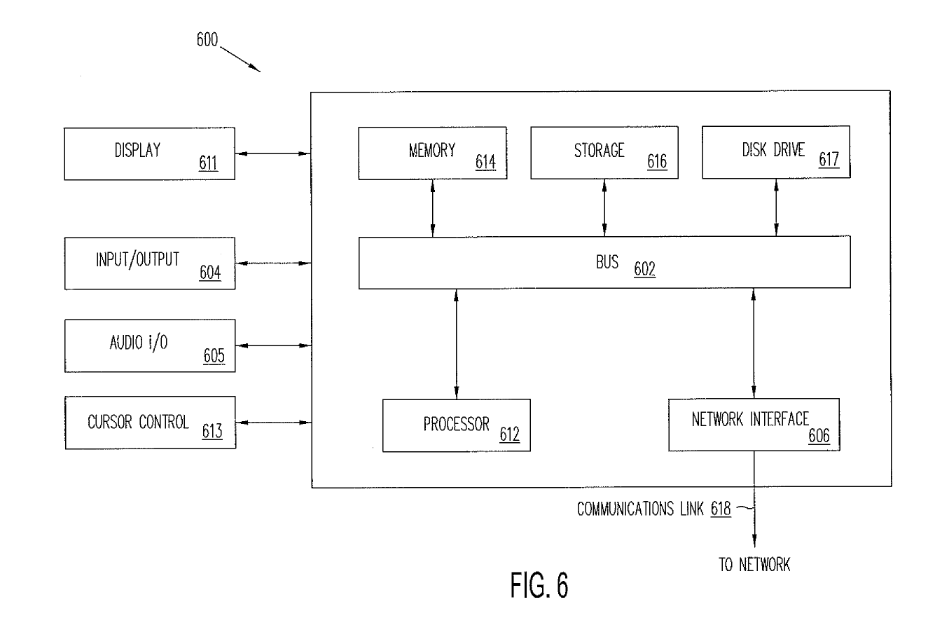

FIG. 6 is a block diagram of a computer system 600 suitable for implementing one or more embodiments of the present disclosure. In various implementations, the mobile device of the user may comprise a personal computing device (e.g., smart phone, a computing tablet, a personal computer, laptop, PDA, Bluetooth device, key FOB, badge, etc.) capable of communicating with the network. The merchant server and/or the payment processing gateway may utilize a network computing device (e.g., a network server) capable of communicating with the network. It should be appreciated that each of the devices utilized by users, merchants, and payment providers may be implemented as computer system 600 in a manner as follows. It should also be appreciated that the applications to checkout purchases or process payments may be implemented as applications running on computer system 600.

Computer system 600 includes a bus 602 or other communication mechanism for communicating information data, signals, and information between various components of computer system 600. Components include an input/output (I/O) component 604 that processes a user action, such as selecting keys from a keypad/keyboard, selecting one or more buttons or links, etc., and sends a corresponding signal to bus 602. I/O component 604 may also include an output component such as a display 611, and an input control such as a cursor control 613 (such as a keyboard, keypad, mouse, etc.). An optional audio input/output component 605 may also be included to allow a user to use voice for inputting information by converting audio signals into information signals. Audio I/O component 605 may allow the user to hear audio. A transceiver or network interface 606 transmits and receives signals between computer system 600 and other devices, such as another user device, a merchant server, or a payment provider server via a communication link 618 to a network. In one embodiment, the transmission is wireless, although other transmission mediums and methods may also be suitable. A processor 612, which can be a micro-controller, digital signal processor (DSP), or other processing component, processes these various signals, such as for display on computer system 600 or transmission to other devices via communication link 618. Processor 612 may also control transmission of information, such as cookies or IP addresses, to other devices.

Components of computer system 600 also include a system memory component 614 (e.g., RAM), a static storage component 616 (e.g., ROM), and/or a disk drive 617. Computer system 600 performs specific operations by processor 612 and other components by executing one or more sequences of instructions contained in system memory component 614. Logic may be encoded in a computer readable medium, which may refer to any medium that participates in providing instructions to processor 612 for execution. Such a medium may take many forms, including but not limited to, non-volatile media, volatile media, and transmission media. In various implementations, non-volatile media includes optical, or magnetic disks, or solid-state drives, volatile media includes dynamic memory, such as system memory component 614, and transmission media includes coaxial cables, copper wire, and fiber optics, including wires that comprise bus 602. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 618 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Application software in accordance with the present disclosure, such as computer programs executed by a processor of the payment processing gateway to process payment or computer programs executed by a processor of the merchant server for product checkout may be stored on one or more computer readable mediums. It is also contemplated that the application software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Although embodiments of the present disclosure have been described, these embodiments illustrate but do not limit the disclosure. For example, even though a system and method is described for a browser to use a full-duplex connection with a payment processing gateway to authorize payment processing, the system and method may be extended to the use of a full-duplex connection between a client device and a payment processing server for other types of financial transactions. Similarly, communication channels between the client device and the merchant server may be implemented as a full-duplex connection to facilitate purchase transactions. It should also be understood that embodiments of the present disclosure should not be limited to these embodiments but that numerous modifications and variations may be made by one of ordinary skill in the art in accordance with the principles of the present disclosure and be included within the spirit and scope of the present disclosure as hereinafter claimed.

We claim:

1. An apparatus of a service provider comprising:
one or more processors;
a memory adapted to store a plurality of machine-readable instructions wherein the memory is executed by the one or more processors to:
receive a request from a browser of a communication device to establish a secure full-duplex communication channel between the apparatus and the browser;
establish the secure full-duplex communication channel between the apparatus and the browser;
receive information to process a financial transaction from the browser over the secure full-duplex communication channel;
process the financial transaction; and
transmit results of the financial transaction to the browser over the secure full-duplex communication channel.

2. The apparatus of claim 1, wherein the financial transaction is for a transaction between the communication device and a merchant server, and wherein the memory is further adapted to be executed by the one or more processors to exchange information with the merchant server to facilitate the establishment of the secure full-duplex communication.

3. The apparatus of claim 2, wherein the memory executed by the one or more processors to exchange information comprises the memory being further adapted to be executed by the one or more processors to return a security token to the merchant server, wherein the security token is received from the browser as part of the request to establish the secure full-duplex communication channel between the apparatus and the browser.

4. The apparatus of claim 1, wherein the secure full-duplex communication is implemented using WebSocket Protocol.

5. The apparatus of claim 1, wherein the information to process the financial transaction received from the browser comprises credit card information of a credit card authorized to be used as a payment source for the financial transaction.

6. The apparatus of claim 1, wherein the information to process the financial transaction received from the browser comprises account information of a bank account authorized to be used as a payment source for the financial transaction.

7. The apparatus of claim 1, wherein the information to process the financial transaction received from the browser comprises information of a receiving account used to receive a payment of the financial transaction.

8. The apparatus of claim 1, wherein the memory executed by the one or more processors to process the financial transaction comprises the memory being further adapted to be executed by the one or more processors to transmit the information to process the financial transaction received from the browser to a payment processing network for the payment processing network to process the financial transaction.

9. The apparatus of claim 1, wherein the memory executed by the one or more processors to process the financial transaction comprises the memory being further adapted to be executed by the one or more processors to debit a payment amount from a payment source and to credit the payment amount to a receiving account.

10. The apparatus of claim 1, wherein the results of the financial transaction is transmitted by the apparatus to the browser to be displayed on a webpage that accepts the information to process the financial transaction received by the apparatus from the browser.

11. A method comprising:
receiving by a processor of a service provider device a request from a browser of a communication device to establish a secure full-duplex communication channel between the service provider device and the browser;
establishing the secure full-duplex communication channel between the service provider device and the browser;
receiving by the processor information to process a financial transaction from the browser over the secure full-duplex communication channel;
processing the financial transaction; and
transmitting by the processor results of the financial transaction to the browser over the secure full-duplex communication channel.

12. The method of claim 11, wherein the financial transaction is for a transaction between the communication device and a merchant server, and wherein the method further comprises exchanging information by the processor with the merchant server to facilitate the establishment of the secure full-duplex communication.

13. The method of claim 12, wherein said exchanging information by the processor with the merchant server further comprises returning a security token to the merchant server, wherein the security token is received from the browser as part of the request to establish the secure full-duplex communication channel between the service provider device and the browser.

14. The method of claim 11, wherein the secure full-duplex communication is implemented using Web Socket Protocol.

15. The method of claim 11, wherein the information to process the financial transaction received from the browser comprises credit card information of a credit card authorized to be used as a payment source for the financial transaction.

16. The method of claim 11, wherein the information to process the financial transaction received from the browser comprises account information of a bank account authorized to be used as a payment source for the financial transaction.

17. The method of claim 11, wherein the information to process the financial transaction received from the browser comprises information of a receiving account used to receive a payment of the financial transaction.

18. The method of claim 11, wherein said processing the financial transaction further comprises transmitting the information to process the financial transaction received from the browser to a payment processing network for the payment processing network to process the financial transaction.

19. The method of claim 11, wherein said processing the financial transaction further comprises debiting a payment amount from a payment source and crediting the payment amount to a receiving account.

20. The method of claim 11, wherein said transmitting the results of the financial transaction to the browser further comprises transmitting the results for display on a webpage that accepts the information to process the financial transaction received by the processor from the browser.
